(19) United States
(12) Patent Application Publication
(10) Pub. No.: US 2007/0154209 A1
(43) Pub. Date: Jul. 5, 2007

(54) Lens filter selection device

(75) Inventor: Keng-Ming Chang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/439,924

(22) Filed: May 24, 2006

(30) Foreign Application Priority Data
Dec. 30, 2005 (CN) 200510121394.7

(51) Int. Cl. G03B 11/00

(52) U.S. Cl. 396/544

(57) ABSTRACT

A selective device (100) for lens filters comprises a body (10), a rotatable component (30) and a plurality of lens filters (50). The body (10) includes a through hole (15). The rotatable component (30) is rotatably installed on the body (10). The rotatable component (30) includes a plurality of filter holes (33) defined therein and each filter hole (33) can be selectably aligned with its respective through hole (15). The lens filters (50) are each installed in a corresponding one of the filter holes (33).

### TECHNICAL FIELD

The present invention relates to a lens filter selection device of camera modules used in portable devices, such as mobile telephones, electronic notebooks, and so on.

### BACKGROUND

With the development of wireless communication and information processing, portable electronic devices, such as mobile telephones and PDAs (personal digital assistants), are now in widespread use. These electronic devices enable consumers to enjoy convenience of high technology services, anytime and anywhere. The camera module has been an important member of portable electronic devices.

Generally, a camera module used in a portable device includes a lens module and an image sensor module. The lens module focuses optical signals and transfers the optical image signals to the image sensor module, and the image sensor module transforms the optical image signals to electrical signals for taking photos. For improving quality of the photos, the camera module often needs a lens filter for filtering unwanted optical signals, and in different conditions the lens filter can be replaced.

In a typical camera module, the lens filter is installed in the lens module via screw threads. When replacing the lens filter the user needs to rotate the lens filter along the screw threads, but the camera module used in a portable device is usually very small, and therefore it is difficult to replace the lens filter. Additionally, the lens module of the camera module is mostly made of plastic, thus it is easy to damage the projections whilst replacing the lens filter and the life-span of the lens module is likely to be shortened as a result.

What is needed, therefore, is a new lens filter selection device of camera modules used in portable devices that can be easily used to replace the lens filter and can avoid to damage the lens module.

### SUMMARY

In a preferred embodiment, a lens filter selection device comprises a body, a rotatable component and a plurality of lens filters. The body includes a through hole. The rotatable component is rotatably installed on the body. The rotatable component includes a plurality of filter holes defined therein and each filter hole can be selectably aligned with its respective through hole. The lens filters are each installed in its respective filter hole.

Other advantages and novel features will become more apparent from the following detailed description when taken in conjunction with the accompanying drawings.

### BRIEF DESCRIPTION OF THE DRAWINGS

Many aspects of the lens filter selection device can be better understood with reference to the following drawings. The components in the drawings are not necessarily drawn to scale, the emphasis instead being placed upon clearly illustrating the principles of the present lens filter selection device. Moreover, in the drawings, like reference numerals designate corresponding parts through out the several views.

FIG. 1 is an isometric view of a lens filter selection device in accordance with a first embodiment of the present invention;

FIG. 2 is an isometric cut-away view of a rotatable component and a lens filter of the selective device; and

FIG. 3 is an isometric view of a lens filter selection device in accordance with a second embodiment of the present invention.

### DETAILED DESCRIPTION OF PERFERRED EMBODIMENTS

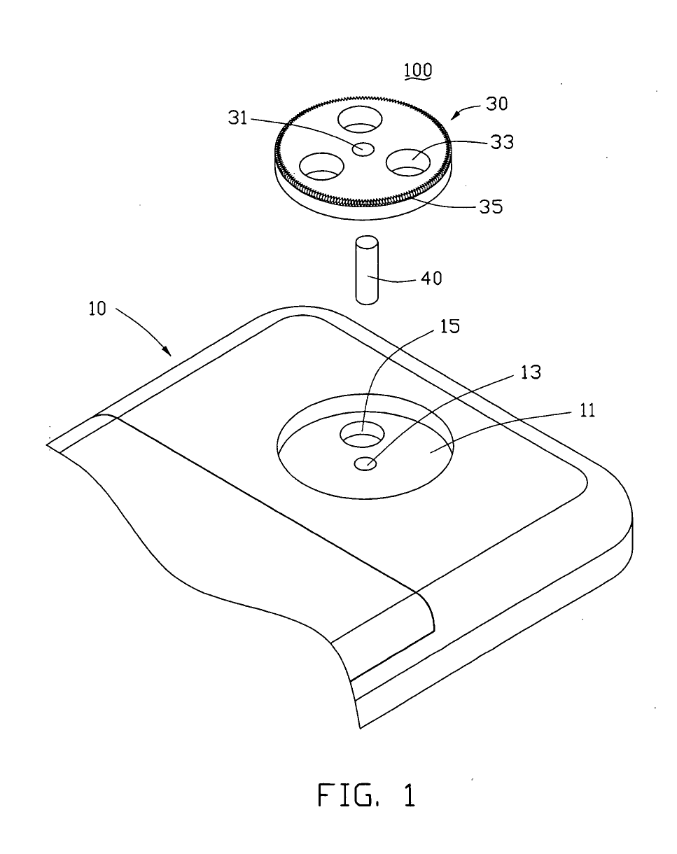

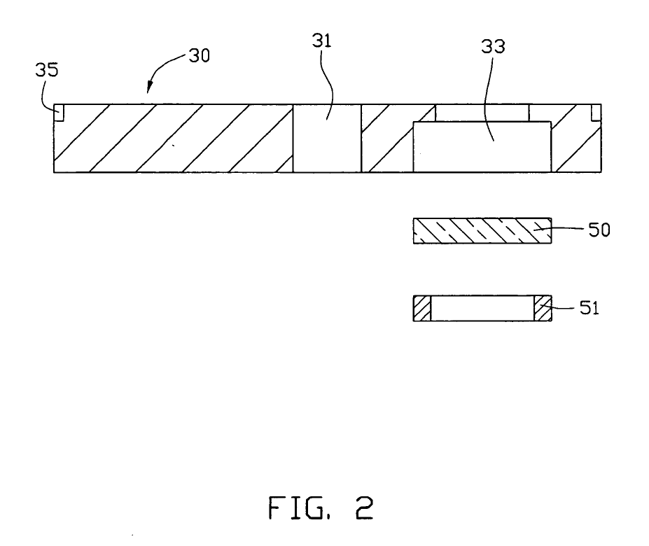

Referring now to the drawings, FIG. 1 shows a selective device 100 according a first embodiment of the present invention. Also referring to FIG. 2, the selective device 100 used in a camera module (not shown) of a mobile phone includes a body 10, a rotatable component 30, a pole 40 and a plurality of lens filters 50. The rotatable component 30 is rotatably installed on the body 10 via the pole 40. The lens filters 50 are installed on the rotatable component 30.

The body 10 is a board which is a part of a housing of the mobile phone. A round recess 11 is defined in the body 10. A first fixing hole 13 and a through hole 15 are defined through the body 10. The first fixing hole 13 and the through hole 15 both communicate with the round recess 11. The round recess 11 and the first fixing hole 13 are arranged coaxially. The through hole 15 is arranged in parallel with the first fixing hole 13. A lens module (not shown) of the camera module is located to be aligned with the through hole 15 so that optical image signals can enter the lens module by traveling through the through hole 15.

The rotatable component 30 is a disk that includes a second fixing hole 31 and a plurality of filter holes 33. The second fixing hole 31 is defined in a center of the rotatable component 30. The filter holes 33 are defined in a peripheral portion of the rotatable component 30. The filter holes 33 are arrayed round the second fixing hole 31 equidistantly. The rotatable component 30 is rotatably installed in the round recess 11 of the body 10 via the pole 40 traversing the second fixing hole 31 and the first fixing hole 13. When the rotatable component 30 rotates in the round recess 11, each of the filter holes 33 can be selectably aligned with the through hole 15. A plurality of projections 35 are formed on an outer surface of the rotatably component 30 for facilitating manual rotating operation on the rotating component.

The lens filters 50 are shaped as thin column flakes whose diameter fits the filter holes 33. A plurality of holding loops 51 are used to hold the lens filters 50. Alternatively, the lens filters 50 can be installed in the filter holes 33 by other ways such as gluing and interferingly fixing.

In assembly, the user can install the lens filters 50 in the filter holes 33 respectively and hold the lens filters 50 via the holding loops 51. The rotatable component 30 is installed in the round recess 11 of the body 10 via the pole 40 traversing the second fixing hole 31 and the first fixing hole 13. Thus the selective device 100 is assembled and the rotatable component 30 can rotate in the round recess 1.

In use, the user can rotate the rotatable component 30 to align a proper lens filter 50 in the filter hole 33 with the through hole 15 of the body 10. Optical image signals entering the lens module through the through hole 15 are filtered by the lens filter 50. When another lens filter 50 is needed, the user can rotate the rotatable component 30 again, until the needed lens filter 50 in another filter hole 33 is aligned with the through hole 15.

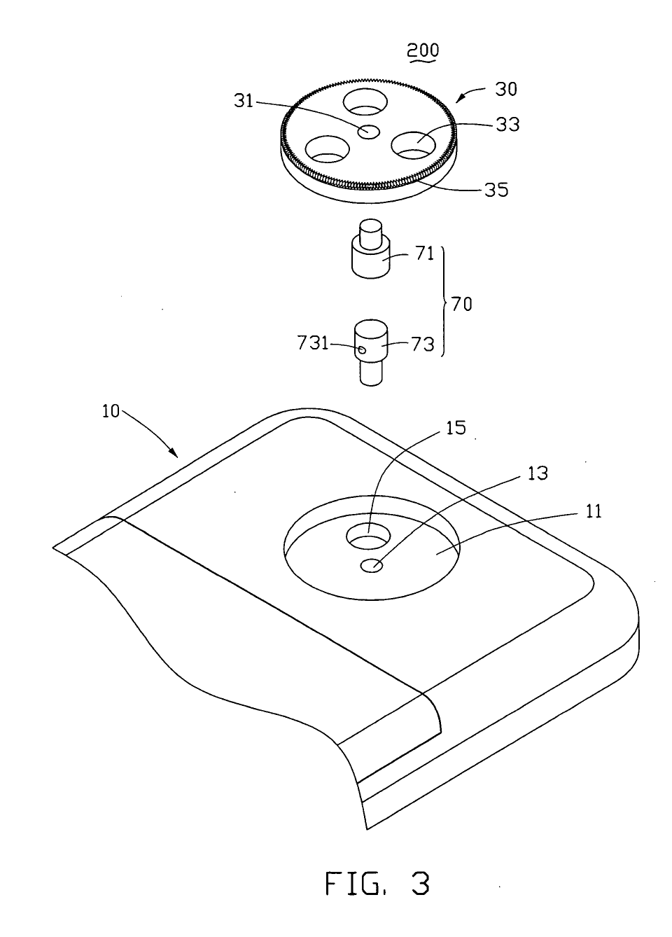

Referring to FIG. 3, a selective device 200 according to a second embodiment is provided. The selective device 200 is similar to the selective device 100 except that the selective device 200 includes a retainer 70 replacing the pole 40 of the selective device 100. The retainer 70 is mounted between the body 10 and the rotatable component 30 so that the lens filter 50 in the filter hole 33 may be aligned with the through hole 15 more exactly. The retainer 70 includes a pipe 71 and an axis 73 that can be rotatably contained in the pipe 71. The axis 73 can be secured in the first fixing hole 13 of the body 10 and the pipe 71 can be secured in the second fixing hole 31 of the rotatable component 30. A plurality of grooves (not shown) corresponding to the filter holes 33 are defined in an inner surface of the pipe 71. At least one latching protrusion 731 made of elastic material is defined on an outer surface of the axis 73. The latching protrusion 731 cooperates with the grooves to align the filter holes 33 with the through hole 15.

When rotating the rotatable component 30, the pipe 71 is driven to rotate around the axis 73. The latching protrusion 731 defined on the outer surface of the axis 73 can be retained in any groove and be exerted from any groove into any other groove depending on its elasticity. When the latching protrusion 731 is retained in a groove, the filter hole 33 corresponding with this groove is aligned with the through hole 15 of the body 10. In this way, the user can choose filter holes 33 containing a lens filter 50 to align with the through hole 15 for taking photos.

In assembly, the user can install the lens filters 50 in the same way as assembling the selective device 100, installing the axis 73 into the pipe 71 to enable the latching protrusion 731 to be retained in any groove or be moved from any groove into any other groove. The axis 73 is then secured in the first fixing hole 13 of the body 10 and the pipe 71 is then secured in the second fixing hole 31 of the rotatable component 30, finally the rotatable component 30 is installed in the round recess 11 rotatably.

In use, the user can rotate the rotatable component 30 to choose a suitable lens filter 50 from among a plurality of lens filters 50 installed in the filter holes 33. Therefore the selective device 200 need not be disassembled to replace a lens filter 50. In this way, the selective device 200 can avoid removing and installing the lens filters 50 continuously, thus the life-span of the camera module is extended.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lens filter selection device, comprising:
a body including a through hole;
a rotatable component being rotatably installed on the body, the rotatable component including a plurality of filter holes defined therein, each filter hole being selectable to align with the through hole by rotating the rotatable component; and
a plurality of lens filters each being installed in its respective filter hole.

2. The lens filter selection device as claimed in claim 1, wherein the body is a board which is a part of the housing of a mobile phone, a round recess is defined on the body, and the through hole is defined on the bottom of the round recess.

3. The lens filter selection device as claimed in claim 2, wherein the rotatable component is a disk and the rotatable component is rotatably installed in the round recess of the body.

4. The lens filter selection device as claimed in claim 1, wherein the filter holes are defined in a peripheral portion of the rotatable component, and the filter holes are arrayed equidistantly.

5. The lens filter selection device as claimed in claim 1, wherein the lens filters are installed in the filter holes via a plurality of holding loops.

6. The lens filter selection device as claimed in claim 1, wherein a plurality of projections are formed on the outer surface of the rotatably component for facilitating manual rotating operation on the rotating component.

7. The lens filter selection device as claimed in claim 2, wherein a first fixing hole is defined in the center of the bottom of the round recess, a second fixing hole is defined in the center of the rotatable component; a retainer is mounted between the body and the rotatable component, the retainer has opposite two ends, one end is received in the first fixing hole, and the other end is received in the second fixing hole.

8. The lens filter selection device as claimed in claim 7, wherein the retainer includes a pipe and an axis rotatably received in the pipe, the axis is secured in the first fixing hole, and the pipe is secured in the second fixing hole.

9. The lens filter selection device as claimed in claim 7, wherein a plurality of grooves corresponding to the filter holes are defined in an inner surface of the pipe, at least one latching protrusion made of elastic material is formed on the outer surface of the axis, and the latching protrusion selectively engages into a corresponding one of the grooves so as to align a corresponding one of the filter holes with the through hole.

10. A portable electronic device comprising:
a housing with a lens module received therein, the housing having a through hole being aligned with the lens module; and
a rotating member mounted to the housing, the rotating member having a plurality of filter holes each receiving a filter therein, the rotating member being configured so as to be rotatable with respect to the body to allow the filters to be selectably aligned with the through hole.

11. The portable electronic device as claimed in claim 11, wherein a plurality of projections are formed on an outer surface of the rotating member for facilitating manual rotating operation on the rotating component.

12. The portable electronic device as claimed in claim 11, wherein a holding loop is engaged in each filter hole so as to preventing the filter from falling out.

13. The portable electronic device as claimed in claim 11, wherein a retainer is mounted between the housing and the rotating member, and the rotating member rotates around the retainer.
